(19) United States
(12) Patent Application Publication
(10) Pub. No.: US 2026/0200710 A1
(43) Pub. Date: Jul. 16, 2026

(54) LOAD CARRIER CONVEYING UNIT WITH COMPACT ROLLER ARRANGEMENT

(71) Applicant: FILICS GmbH, München (DE)

(72) Inventors: Gregor KOLLS, München (DE); Johannes Julius LUTZER, Eching (DE); Robin KONRAD, München (DE)

(73) Assignee: FILICS GmbH, München (DE)

(21) Appl. No.: 19/135,571

(22) PCT Filed: Dec. 4, 2023
(86) PCT No.: PCT/EP2023/084105

§ 371 Date: Jun. 4, 2025

(30) Foreign Application Priority Data
Dec. 5, 2022 (DE) 10 2022 132 179.7

(51) Int. Cl. B66F 9/065; B66F 9/06; B66F 9/075

(52) U.S. Cl. CPC B66F 9/065; B66F 9/063; B66F 9/07568

(57) ABSTRACT

A conveyor unit for conveying load carriers, comprising
an elongate frame structure with a front frame section and a rear frame section, each of which has a roller arrangement with at least two rollers mounted for rotation about a vertical axis of rotation relative to the frame structure;
a support element which can be brought into contact with a load carrier and which can be moved vertically relative to the frame structure between a raised position and a lowered position by means of a lifting device;
   wherein each of the roller arrangements has at least one roller which can be driven by means of a roller drive designed as a wheel hub drive.

### The invention relates to a conveyor unit for conveying load carriers, and also to a conveyor device with several, specifically two, such conveyor units.

For the internal transport of goods, load carriers are regularly used which can be driven under industrial trucks, lifted together with the goods stored on them and settled down again at their destination after transport. A well-known example of such a load carrier is the standardised and reusable “Euro pallet”.

Various types of industrial trucks are known from the state of the art, which are referred to below as conveyor systems. A distinction can be made between single-part and multi-part conveyor systems. In the former, as shown for example in EP 2 336 075A1, the sections of the conveyor that pass under the load carrier are firmly connected to each other. Multi-part conveyor systems, as shown for example in DE 10 2007 046 868A1, usually comprise a first and a second conveyor unit that are not physically connected to each other. Conveyor systems can also be differentiated in terms of their actuation. On the one hand, manual or motorised operation is possible, as is the case with hand pallet trucks, for example, which are regularly used for loading and unloading lorries. On the other hand, autonomously operated conveyor systems are also known, see again EP 2 336 075A1.

DE 10 2007 046 868 A1 proposes using just one electric motor to perform all the necessary movements of the transport system. A square base area is required for this drive system, which requires the full width of the load carrier and an identical length. Such a design with the associated arrangement of the rollers also does not allow travel perpendicular to the longitudinal axis of the conveyor unit, as it would otherwise tilt. Similar conveyor systems are known, for example, from DE 10 2013 013 684A1, EP 3 216 747 A2 or WO 2018/136987A1. These drive systems all have two wheels that can rotate around a common axis of rotation and which rotate around a vertical axis. The disadvantage of these drive systems is their space-consuming design and the impossibility of travelling in a direction perpendicular to the longitudinal axis of the conveyor unit.

In the case of autonomously operated conveyor systems that drive completely underneath the load carriers to be transported, the clearance profile provided by the corresponding load carriers, i.e. the space available for the conveyor system when moving in or out under the load carrier placed on the ground, is a very important limiting factor. All components required for the function and operation of the conveyor system must be able to fit within the available height, width and length, whereby certain minimum distances in height and width must also be maintained in relation to the load carrier in order to ensure trouble-free entry and exit.

The task of the present invention is to provide a conveyor unit or a conveyor device with several such conveyor units, which has compact roller arrangements and can be moved omnidirectionally.

This problem is solved by the subject matter of independent claim 1. The dependent claims define preferred embodiments of the present invention.

The conveyor unit for conveying load carriers according to the invention thus comprises
an elongate frame structure with a front frame section and a rear frame section, each of which has a roller arrangement with at least two rollers mounted for rotation about a vertical axis of rotation relative to the frame structure;
a support element which can be brought into contact with a load carrier and which can be moved vertically relative to the frame structure between a raised position and a lowered position by means of a lifting device; wherein each of the roller arrangements has at least one roller which can be driven by means of a roller drive designed as a wheel hub drive.

In other words, the functional components required to move the conveyor unit are combined in a compact unit and housed within the respective driven rollers of the conveyor unit. It should be noted at this point that it may be sufficient if only individual rollers of the conveyor unit have such a drive. It is also conceivable that all rollers of a conveyor unit have such a drive.

In one embodiment, the roller drive designed as a wheel hub drive can be arranged within the rotational steering circle, i.e. turning circle, of the roller. This so-called turning circle is defined by the tread of the associated roller when this roller is rotated about its vertical axis of rotation. In other words, the areas of the tread furthest away from the axis of rotation draw a boundary for an area or volume when the roller is rotated, which defines the maximum construction volume available for the roller drive. Turned around again, in any angular position of the roller, the roller tread is the element furthest away from the roller axis of rotation. This can apply, for example, to a projection along the roller's axis of rotation, as well as to the three-dimensional volume, which is defined by a complete rotation of the roller around its axis of rotation.

In a further embodiment, the roller drive can comprise an electric motor, a gearbox (i.e. gear or gearing) coupling the electric motor and the roller, a brake counteracting the drive torque of the electric motor and a control unit controlling the electric motor, specifically wherein the electric motor, the gearbox and the brake are arranged coaxially to the axis of rotation of the roller, which can extend essentially in a horizontal direction. Furthermore, the brake, like the electric motor, can be arranged on the gearbox input side. The braking torque generated by the brake can thus be transmitted by means of the gearbox and, for example, act at least indirectly on the gearbox input shaft. The roller arranged on the transmission output side thus experiences a braking torque that is converted by the transmission ratio, specifically an increased braking torque. Specifically, the brake can run at the same speed as the electric motor and/or at the same speed as the roller. The conversion of the braking torque via the gearbox enables the use of a smaller brake, which ultimately allows it to be installed in the roller unit, especially given the limited space available within the roller unit.

It is also conceivable that the power electronics of the electric motor and/or any integrated encoder sensor is also included in the roller drive and is therefore also located within the rotation circuit of the roller. Such a design allows the necessary cabling to be reduced to a minimum, which also has a positive effect on the compactness of the roller drive. Furthermore, the cabling, which for example ensures the data and/or power coupling of the roller unit with other components of the conveyor unit, can extend at least in sections between an interface that is fixed relative to the frame structure of the conveyor unit and an interface that rotates about its vertical axis of rotation in accordance with the rotational movement of the roller unit. In order to avoid stress on the cabling caused by the rotational movement of the roller unit, the cable can be laid in the form of a cable loop between the aforementioned interfaces or other fixations that secure the cable relative to the frame structure or the roller unit. This cable loop can run around the vertical axis of rotation of the roller unit, specifically essentially in a horizontal plane, whereby elements of the roller unit rotating around the vertical axis of rotation, specifically the cable interface or cable fixed point, can be located in a vertical projection within the cable loop.

According to a further embodiment, the bearing for supporting the roller unit formed by the roller and the roller drive is arranged inside the pivot circle of the roller in relation to the frame structure. It is also possible that only the tread of the roller extends beyond the bearing plane. Specifically, it is possible for the roller unit to be mounted relative to the frame structure both above and below the axis of rotation of the roller in the functional position of the conveyor unit. In other words, the roller unit is supported above and below the roller rotation axis on the frame structure, specifically with only the roller tread extending beyond the upper or lower horizontal bearing plane.

In summary, the roller, specifically its tread, can represent a ring, along the bore of which all essential, specifically all functional components of the roller drive are arranged.

According to a further embodiment, the vertical axis of rotation of the roller required to “steer” the conveyor unit is at a distance from the centre plane of the roller, specifically from the centre plane of the roller tread, and can specifically run parallel to it. When the roller rotates about its vertical axis of rotation, an eccentric relative movement, so to speak, takes place between the contact surface of the roller and the ground. Such an arrangement can help to create additional installation space to the side of the roller for drive components.

In a further embodiment, coordination of the rotation about the vertical axis of rotation and the drive of the rollers of a roller arrangement, specifically all the rollers of the conveyor unit, takes place by means of an electronic control system, specifically by means of the control unit and/or the power electronics. In contrast to previous drive concepts for conveyor units, the conveyor unit according to the invention does not mechanically couple individual rollers. Instead, these are coupled to one another solely by means of control electronics in order to execute a desired travelling movement.

It is also conceivable that the roller arrangements of the conveyor unit are designed as modules of identical construction, which are specifically interchangeable. A conveyor unit according to the invention can thus have two identical roller arrangement modules, between which—apart from a possibly different, installation position-related control or programming—there is no difference. Specifically, it is conceivable that the modules can be removed from the conveyor unit and re-inserted into it without tools or with comparatively little use of tools. This type of design significantly reduces the costs of stocking spare parts as well as the maintenance effort.

It is also possible for a line connecting the contact surfaces of the rollers of a roller arrangement to run perpendicular to the longitudinal axis of the frame structure, specifically with the rollers of the roller arrangement assuming a mirror-symmetrical position relative to the longitudinal axis of the frame structure.

By placing roller units next to each other, so to speak, the necessary construction volume along the longitudinal axis of the conveyor unit is reduced to a minimum. The contact surfaces of a four-wheeled running gear of the conveyor unit therefore form a rectangle when viewed from above.

In an alternative embodiment, a line connecting the contact surfaces of the rollers of a roller arrangement extends obliquely relative to the longitudinal axis of the frame structure, specifically wherein the rollers of a roller arrangement assume a rotationally symmetrical position relative to the longitudinal axis of the frame structure.

Here, the contact surfaces of a four-wheeled running gear of the conveyor unit would describe a parallelogram in a vertical view. This design can help to reduce the width of the necessary installation frame, i.e. transverse to the longitudinal axis of the conveyor unit.

Both embodiments described above allow the conveyor unit to be moved perpendicular to its longitudinal axis. Even with the axes of rotation of the rollers aligned parallel to the longitudinal axis of the conveyor unit, the contact surfaces of the rollers are spaced on both sides of the central longitudinal axis of the conveyor unit, so that the entire conveyor unit can be supported by these contact surfaces when travelling transversely to its longitudinal axis.

As the dissipation of heat losses becomes more important with increasing compactness of the roller units, it may be provided that individual or the main components of the roller unit are made of materials that have a comparatively high thermal conductivity. Contact surfaces between such components can also be treated with materials or substances with particularly good thermal conductivity. This can improve the dissipation of heat to the immediate surroundings or, for example, into the frame structure.

According to one embodiment, the entire roller drive is arranged within the bearing of the roller unit (or the bearing diameter) in the frame, particularly when viewed in the vertical and/or horizontal direction.

Furthermore, it is conceivable that the entire roller drive, including the bearing, is located within the wheel diameter, particularly when viewed in a vertical and/or horizontal direction. Thus, the tread of the roller can be the component of the roller unit furthest away from the roller rotation axis.

According to a further embodiment, the roller unit comprises a support structure, specifically a one-piece support element, which is supported, specifically directly supported, on the support structure via a first rolling bearing and on which, in turn, the roller and/or the ring gear of the gearbox designed as a planetary gearbox is supported, specifically directly supported, via a second rolling bearing. This makes it possible to minimise the flow of force between the roller and the frame structure. The forces and torques acting from the ground on the tread of the roller can thus be transferred directly to the support structure via the support structure, and vice versa. It is advantageous if the support structure extends as close as possible to the axis of rotation of the roller, as this minimises moments and reduces the stress on the material. The support structure can support any component of the roller drive, such as the electric motor, the gearbox, the brake, the control unit, the power electronics or any combination thereof, specifically by directly supporting or even contacting it.

A further aspect of the present invention relates to a conveyor device with several, specifically two conveyor units according to one of the embodiments described above.

The present invention is described in more detail below with reference to preferred embodiments and with reference to the accompanying figures. The invention may comprise all of the features described herein individually as well as in any useful combination.

### IT IS SHOWN IN

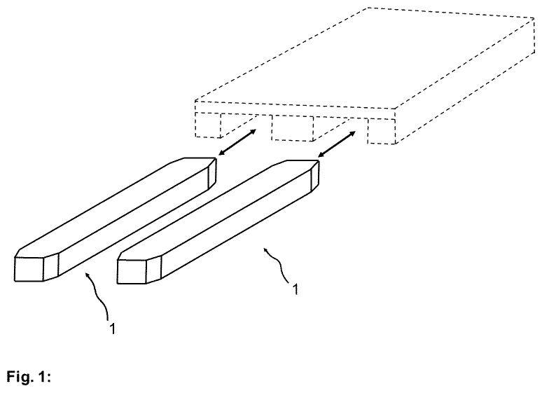

FIG. 1: a conveyor device according to the present invention, comprising two conveyor units;

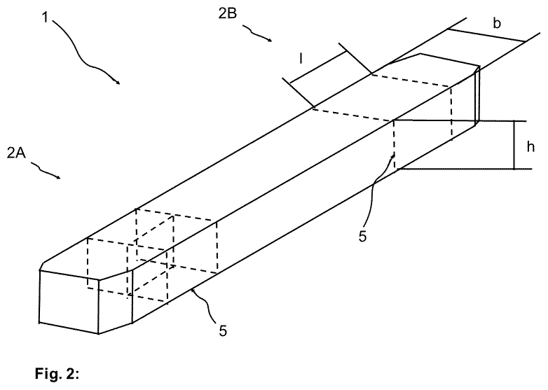

FIG. 2: a conveyor unit according to the invention with schematically illustrated roller arrangements;

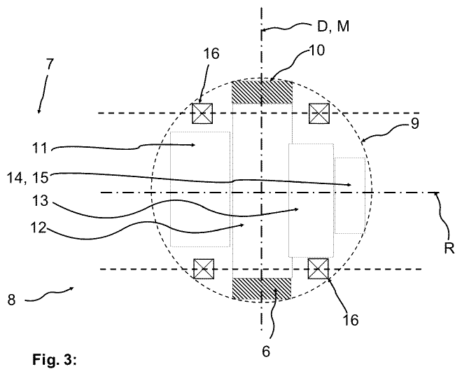

FIG. 3: a cross-section of a first embodiment of a roller unit according to the invention;

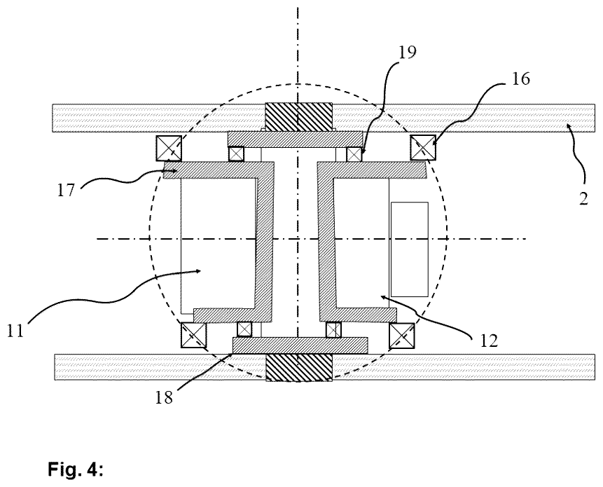

FIG. 4: a cross-section through a further embodiment of a roller unit according to the invention

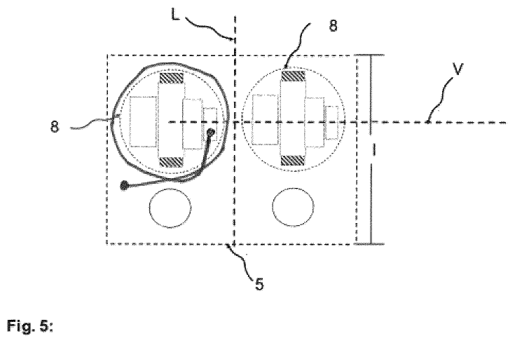

FIG. 5: a top view of a first embodiment of a roller arrangement according to the invention; and

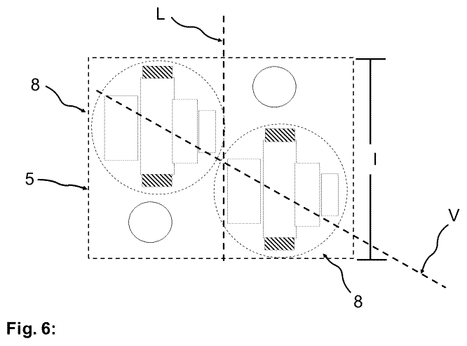

FIG. 6: a top view of a second embodiment of the roller arrangement according to the invention.

FIG. 1 shows a two-part conveyor system with two conveyor units 1 that are not physically connected to each other. Such autonomously operated conveyor systems are known, for example, from DE 10 2007 046 868 A1 and DE 10 2019 001 125A1. FIG. 1 also shows how the conveyor units can completely underride a load carrier (transport pallet/“Euro pallet”) in the lowered state in order to subsequently lift the load carrier for transport.

The conveyor unit 1 shown in FIG. 2 has, in addition to a non-illustrated support element for lifting a load carrier, a frame structure which, in the example shown in FIG. 2, is divided into a front frame section 2A and a rear frame section 2B. A predefined construction volume is provided in both the front frame section 2A and the rear frame section 2B, which serves to accommodate a roller arrangement 5 with two rollers in each case. All components of the roller arrangements 5 must therefore be accommodated in the available construction volume, which in turn is limited in its height h and width b by the loading gauge provided by the load carrier. Only the length I of the construction volume available for the roller arrangement 5 can be varied in terms of dimensions, albeit at the expense of other equipment necessary for the functioning of the conveyor unit, such as a lifting device for the carrying element (not illustrated), an energy storage unit or a sensor system necessary for autonomous operation. As a roller arrangement 5 has two identical roller units 8 in the example shown, only half the construction volume is available for the latter.

With the aim of minimising the construction volume of the roller unit 8, as can be seen in FIG. 3, the entire roller drive 7 required to drive a roller 6 is accommodated within a turning circle 9. The turning circle 9 shown in FIG. 3 is defined by rotating the roller 6 by 90° around its axis of rotation D. All components of the roller drive 7, as well as the bearing 16 of the roller unit 8 relative to the frame structure 2 and about the vertical axis of rotation D, are arranged within this turning circle 9.

FIG. 3 also shows that the electric motor 11, the single-stage planetary gearbox (planetary gearing) 12 and the brake 13 are arranged both coaxially to each other and in relation to the axis of rotation R of the roller 6. The installation space still available to the right of the brake 13 is taken up by the control unit 14 and the power electronics 15 for the electric motor 11. The tread 10 of the roller 6 is directly connected to the ring gear of the planetary gear 12, which is not shown, and is the only component that extends beyond the upper and lower horizontal bearing levels defined by the pivot bearings 16.

FIG. 4 shows a roller unit 8 according to the invention in a further embodiment, which comprises a support structure 17 designed as a one-piece element. The support element 17 is supported directly on the frame structure 2 above and below the roller rotation axis R via a roller bearing 16 in each case and can rotate about the vertical rotation axis D. The ring gear 18 of the planetary gear is supported directly on the support element 17 via two further roller bearings 19 above and below the roller rotation axis R and can rotate about the horizontal rotation axis R for this purpose. Due to the direct bearing of the support element 17 on the frame structure 2 on the one hand and the ring gear 18 or the roller 6 on the support element 17 on the other hand, forces are transmitted directly between the frame structure 2 and the roller 6, which increases the stability of the roller unit 8 according to the invention. It can also be seen that the support element 17 extends in a vertical direction close to the vertical axis of rotation D, which also results in a low moment load on the roller unit 8. At the same time, space is created for the electric motor 11 and the brake 12, which are directly supported by the support element 17. In the embodiment shown, the bearing 16 is not located entirely within the turning circle 9, but is located within the diameter of the roller 6 or the tread 10, both horizontally and vertically. The bearing 16 therefore has a smaller diameter than the roller 6 or the tread 10.

FIG. 5 shows a first embodiment of a roller arrangement 5 according to the invention with exactly two roller units 8 arranged “side by side”, as shown in more detail in FIG. 3. The vertical rotation of the respective rollers is achieved by two independent actuators, which are schematically shown as circles in FIG. 4. A mechanical connection to the respective roller units 8 can be made, for example, via a belt drive (not illustrated), although any other type of connection, such as chain drives or gear drives, are conceivable. The independent actuators, which can be designed as an electric motor or servomotor, allow the rollers to be rotated independently of each other about their respective vertical axis of rotation. Since the steering movement of the individual rollers is performed by the actuators assigned to them, the steering of the conveyor unit according to the invention is also completely independent of the drive of the individual rollers by the electric motors 11 assigned to them in each case. Furthermore, FIG. 5 shows an example of a cable for the signal and power supply of the roller unit 8 arranged on the left in FIG. 5. The cable extends between an interface on the frame side and an interface on the roller unit side and forms a cable loop between these interfaces, which runs around the vertical axis of rotation of the roller unit 8. In accordance with the “excess” cable length between the interfaces, this allows a certain number of rotations of the roller unit 8 without any significant stresses occurring on the cable. Alternatively, the points shown in FIG. 5 at both ends of the cable loop can also represent fixed points at which the cable is fixed in position relative to the frame structure or reel unit 8.

In the arrangement shown in FIG. 5, a connecting line V between the contact surfaces of the respective rollers 6 runs perpendicular to the longitudinal axis of the conveyor unit 1. The arrangement of the two roller units 8 shown enables a roller arrangement 5 with a very short length I. The minimum width b is determined by the diameter of the rollers 6 or the diameter of the turning circles 9.

An embodiment with a more compact width b is shown in FIG. 6. Here, the roller units 8 are arranged offset to each other so that their respective contact surfaces can be connected via a connecting line V, which runs diagonally to the longitudinal axis L of the conveyor unit 1.

Although the embodiment shown in FIG. 6 is slightly longer in length I, the diameter of the rollers 6 or the turning circles 9 and thus the total construction volume available for the roller drives 7 and the bearing 16 can be dimensioned larger for a given width b, which results, for example, in lower surface pressure on the contact surfaces of the rollers 6, while still allowing travel perpendicular to the longitudinal axis L of the conveyor unit 1.

1. A conveyor unit for conveying load carriers, comprising
an elongate frame structure with a front frame section and a rear frame section, each of which has a roller arrangement with at least two rollers mounted for rotation about a vertical axis of rotation relative to the frame structure;
a support element which can be brought into contact with a load carrier and which can be moved vertically relative to the frame structure between a raised position and a lowered position by means of a lifting device;
wherein
each of the roller arrangements has at least one roller which can be driven by means of a roller drive designed as a wheel hub drive.

2. The conveyor unit according to claim 1, wherein the roller drive is arranged within the turning circle of the roller, which is swept by the tread of the roller when the roller rotates about the vertical axis of rotation.

3. The conveyor unit according to claim 1, wherein the roller drive comprises an electric motor, a gear coupling the electric motor and the roller, a brake counteracting the drive torque of the electric motor and a control unit controlling the electric motor, wherein specifically the electric motor the gear and the brake are arranged coaxially to the axis of rotation of the roller.

4. The conveyor unit according to claim 3, wherein the roller drive further comprises the power electronics of the electric motor.

5. The conveyor unit according to claim 4, wherein the bearing for supporting the roller unit formed by the roller and the roller drive is arranged relative to the frame structure within the turning circle of the roller, which is swept by the tread of the roller when the roller rotates about the vertical axis of rotation, wherein specifically the roller unit is mounted relative to the frame structure both above and below the axis of rotation of the roller.

6. The conveyor unit according to claim 1, wherein the vertical axis of rotation of the roller is spaced from the centre plane of the roller, specifically from the centre plane of the roller tread, specifically runs parallel thereto.

7. The conveyor unit according to claim 1, wherein the coordination of the rotation about the vertical axis of rotation and the drive of the rollers of a roller arrangement, specifically of all the rollers of the conveyor unit, takes place by means of an electronic control system, specifically by means of the control unit and/or the power electronics.

8. The conveyor unit according to claim 1, wherein the roller arrangements of the conveyor unit are designed as modules of identical construction, which are specifically interchangeable with one another.

9. The conveyor unit according to claim 1, wherein a line connecting the contact surfaces of the rollers of a roller arrangement extends perpendicularly with respect to the longitudinal axis of the frame structure, specifically wherein the rollers of the roller arrangement assume a mirror-symmetrical position with respect to the longitudinal axis of the frame structure.

10. The conveyor unit according to claim 1, wherein a line connecting the contact surfaces of the rollers of a roller arrangement runs obliquely with respect to the longitudinal axis of the frame structure, specifically wherein the rollers of a roller arrangement assume a rotationally symmetrical position with respect to the longitudinal axis of the frame structure
